(19) United States
(12) Patent Application Publication
(10) Pub. No.: US 2026/0039517 A1
(43) Pub. Date: Feb. 5, 2026

(54) PULSE AMPLITUDE MODULATION TRANSITION DENSITY TRIGGER IN A TEST AND MEASUREMENT INSTRUMENT

(71) Applicant: Tektronix, Inc., Beaverton, OR (US)

(72) Inventor: Joshua J. O'Brien, Aloha, OR (US)

(73) Assignee: Tektronix, Inc., Beaverton, OR (US)

(21) Appl. No.: 19/283,096

(22) Filed: Jul. 28, 2025

Related U.S. Application Data
(60) Provisional application No. 63/677,362, filed on Jul. 30, 2024.

(51) Int. Cl. H04L 27/04; H04L 25/03

(52) U.S. Cl. CPC H04L 27/04; H04L 25/03878

(57) ABSTRACT

A test and measurement instrument includes an input for receiving a pulse amplitude modulated n-level (PAMn) signal, an analog-to-digital converter (ADC) coupled to the input to digitize the PAMn signal, an acquisition memory coupled to the ADC and configured to store at least a portion of the digitized PAMn signal as a waveform, trigger circuitry coupled to the ADC and to the acquisition memory, and configured to generate a trigger signal to cause the test and measurement instrument to trigger an acquisition of the waveform, PAMn clock and data recovery (CDR) circuitry configured to decode bits from the PAMn signal, and transition detection logic circuitry coupled to the PAMn CDR circuitry and to the trigger circuitry, and configured to detect symbol transitions based on the decoded bits, and to cause the trigger circuitry to generate the trigger signal in response to detecting a particular symbol transition.

### CROSS REFERENCE TO RELATED APPLICATIONS

This application claims priority to U.S. Prov. Pat. App. No. 63/677,362, filed Jul. 30, 2024, the contents of which are hereby incorporated by reference into this application.

### TECHNICAL FIELD

This disclosure relates to test and measurement instruments, and more particularly to triggering technology for a test and measurement instrument, such as an oscilloscope, for example.

### BACKGROUND

Pulse Amplitude Modulation (PAM) signaling is becoming much more common. Multi-level PAM3, PAM4, PAM8, and PAM16 signaling are all part of key standards. Visualizing or measuring the signal integrity of these signals is much more complicated than traditional non-return-to-zero (NRZ) signaling. Traditional oscilloscope triggering biases the display of the waveform to a subset of the possible transitions. PAM4 has twelve different transitions. PAM8 has fifty-six different transitions. Traditional oscilloscope triggering systems, analog and digital, can use runt triggering to trigger on some of these transition types but not the majority. And triggering on one transition at a time doesn't give a good visual representation of the signal integrity. Embodiments of this disclosure address these and other shortcomings of traditional oscilloscope triggering technology.

### BRIEF DESCRIPTION OF THE DRAWINGS

FIG. 1 is a functional block diagram of a test and measurement instrument, according to embodiments of the disclosure.

FIG. 2 is a functional block diagram of a test and measurement instrument, according to embodiments of the disclosure.

FIG. 3 is a functional block diagram of a test and measurement instrument, according to embodiments of the disclosure.

FIG. 4 is an example eye diagram display of a PAM4 signal.

### DETAILED DESCRIPTION

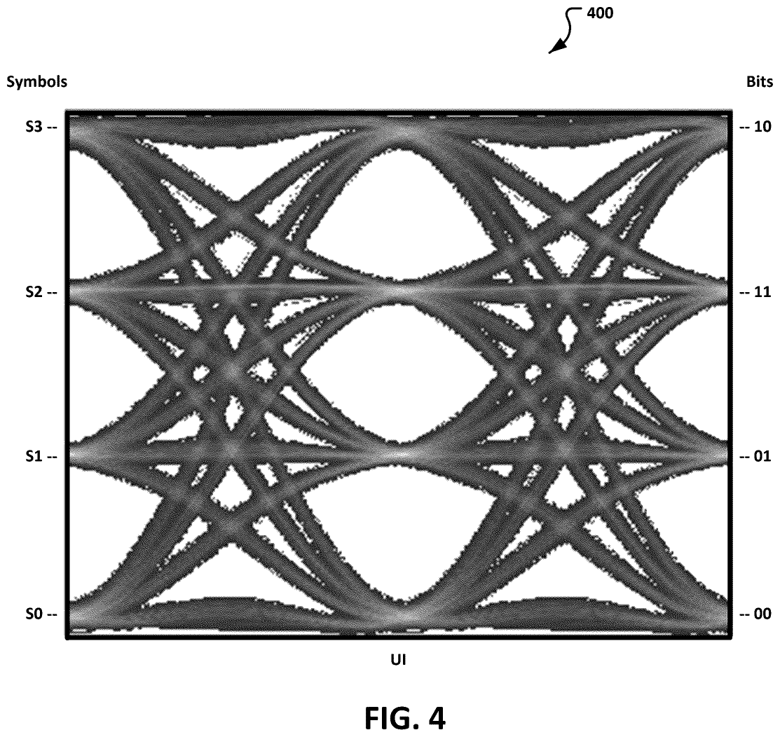

FIG. 4 shows an example eye diagram display 400 of a PAM4 signal. The eye diagram shown in FIG. 4 illustrates the twelve different possible transitions between the four different signal amplitude levels and corresponding four symbols (S0, S1, S2, S3) in a PAM4 signal. The example signal shown in FIG. 4 uses grey coding so that symbol S0, or 0, corresponds to bits 00, symbol S1, or 1, corresponds to bits 01, symbol S2, or 2, corresponds to bits 11, and symbol S3, or 3, corresponds to bits 10. As noted above, traditional oscilloscope triggering systems, analog and digital, can use runt triggering to trigger on some of the twelve different transitions between symbols, but not the majority. And triggering on one transition at a time doesn't give a good visual representation of the signal integrity. For example, for the example PAM4 signal shown in FIG. 4, if the user always triggers on the 0 to 1 transition and there are significant signal integrity issues on the 3 to 1 transition, the user may never see the problem.

Users often trigger on a waveform and enable display persistence to view the noise and jitter on a signal. But this persistence may fail to show problem transitions using current triggering. If the display has grey scaling applied to the persistence, then this further emphasizes the transition most commonly triggered on and disguises issues with other transitions. Users may try to work around this by taking longer acquisitions, but this doesn't solve the problem as some acquisitions may still be dominated by a few transition types and there will be lots of run-to-run variation.

Current oscilloscopes also have high speed serial pattern triggers. These allow for triggering on a specific transition or set of transitions. This doesn't solve the problem either as the persistence will still show one part of the pattern and won't likely represent all of the transitions, especially as the order of PAMn signaling increases.

The first problem to solve is detecting specific transitions. That could be done using traditional analog or digital trigger system using multiple threshold/edge detectors and timers. Depending on the baud rate of the signaling relative to the oscilloscope sample rate, a digital trigger may require interpolation of the data ahead of the trigger system. If there is significant channel loss in the system under test, there may also be a need to equalize the signal ahead of the trigger machine. This is a possible implementation but is so complicated that it isn't practical.

Another method for detecting transitions is to use dedicated transceiver circuitry to receive and decode the serial data in parallel with the analog acquisition. This topology is commonly used in oscilloscopes to provide triggering on high-speed serial data today, but currently only for NRZ signaling. To detect transitions this topology needs to be extended to PAM signaling in an ASIC or FPGA. Custom circuitry after the transceiver would be used to detect specific transitions.

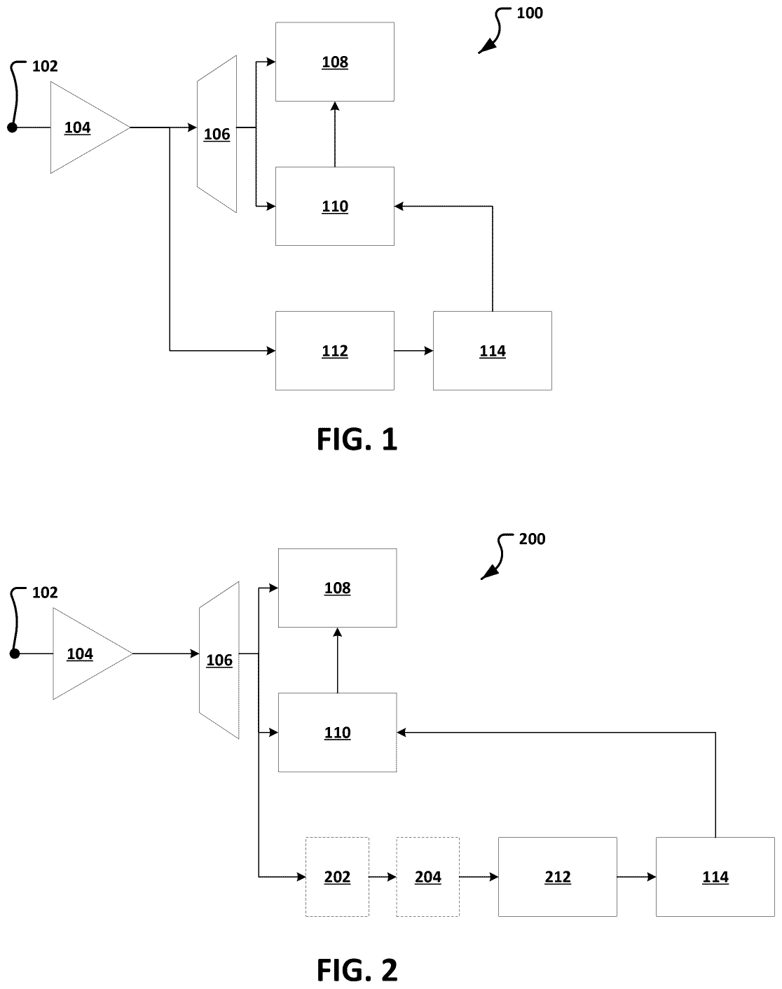

FIG. 1 shows a functional block diagram of a test and measurement instrument 100, such as an oscilloscope, according to some embodiments of this disclosure. The test and measurement instrument 100 includes an input 102, to receive a PAMn signal, where n is greater than or equal to three, such as PAM3, PAM4, PAM8, etc. The received analog PAMn signal is passed from the input 102 to analog front end circuitry to perform signal conditioning on the received input signal. The front end circuitry may include a preamp 104. The preamp 104 amplifies and/or attenuates the input signal and outputs the signal to both an analog-to-digital converter (ADC) 106 and to PAMn Clock and Data Recovery (CDR) circuitry 112. The ADC 106 digitizes the input signal and passes the digitized signal to both an acquisition memory 108 and trigger circuitry 110. The acquisition memory 108 is configured to store at least a portion of the digitized PAMn signal as a waveform. In parallel, the PAMn CDR circuitry 112 operates to decode bits from the analog PAMn signal, according to known CDR techniques. In some embodiments, the PAMn CDR circuitry 112 may be implemented in an FPGA or an ASIC, for example. The decoded bits are passed to Transition Detection Logic circuitry 114. The Transition Detection Logic 114 uses the decoded bits from the CDR 112 and compares them to the previous clock cycle's decoded bits to detect any of the possible PAM transitions. For example, in the example of the PAM4 signal discussed above and shown in FIG. 4, if the CDR 112 decodes bits 01 for the current clock cycle, and the previous clock cycle's decoded bits were 10, the Transition Detection Logic 114 will detect a transition from symbol 3 to symbol 1, which can be also be denoted as 3->1.

The Transition Detection Logic 114 communicates with the trigger circuitry 110 to configure the trigger circuitry 110 to generate a trigger signal in response to detecting a particular signal transition. The trigger signal causes the test and measurement instrument to trigger an acquisition of the waveform when a specific transition is detected. The specific transition, e.g. symbol 3 to symbol 1, may be user-configurable. In some embodiments, trigger circuitry 110 comprises a digital trigger, but in other embodiments analog trigger circuitry may be used.

Another technique for detecting the transitions, according to some embodiments of the disclosure, is illustrated in a test and measurement instrument 200 shown in FIG. 2. The instrument 200 uses clock and data recovery based on the sampled data, rather than the analog input signal. This technique is similar to the technique used in the test and measurement instrument 100 shown in FIG. 1, but doesn't rely on existing analog CDR techniques implemented in an ASIC or FPGA. This digital CDR would rely on the sampled data and would enable triggering on newer standards that may not have support in existing IP.

FIG. 2 shows a functional block diagram of a test and measurement instrument 200, such as an oscilloscope, according to some embodiments of this disclosure. The test and measurement instrument 200 includes an input 102, front end circuitry which may include a preamp 104, ADC 106, acquisition memory 108, and trigger circuitry 110, which are each substantially similar to the identically numbered blocks in the test and measurement instrument 100 of FIG. 1. However, as shown in FIG. 2, in the test and measurement instrument 200, the digitized PAMn signal is output from the ADC 106 to the acquisition memory 108, the trigger circuitry 110, as well as to digital PAMn CDR circuitry 212. Thus, in the test and measurement instrument 200, the CDR is based on sampled data rather than an analog copy sent to a separate receiver circuit. Optionally, prior to the digital CDR, the digitized PAMn signal may also pass through an Interpolation block 202 and/or a Continuous Time Linear Equalizer (CTLE) block 204. The interpolator 202 and CTLE 204 may be needed depending on the speed of the input signal and type of channel. Like the analog PAMn CDR 112 in FIG. 1, the digital PAMn CDR 212 decodes bits from the digitized PAMn signal, and passes the decoded bits to Transition Detection Logic 114 which compares them to the decoded bits from the previous clock cycle, and then communicates with the trigger circuitry 110 to cause it to trigger on specific symbol transitions.

According to some embodiments of this disclosure, once the different transitions are detected, a randomized or round robin trigger can be used to cause a persistent display to overlay the display of all the transitions in equal amounts. This can be done with grey scaling as well. This round robin or random transition selection may be implemented in the trigger circuitry 110.

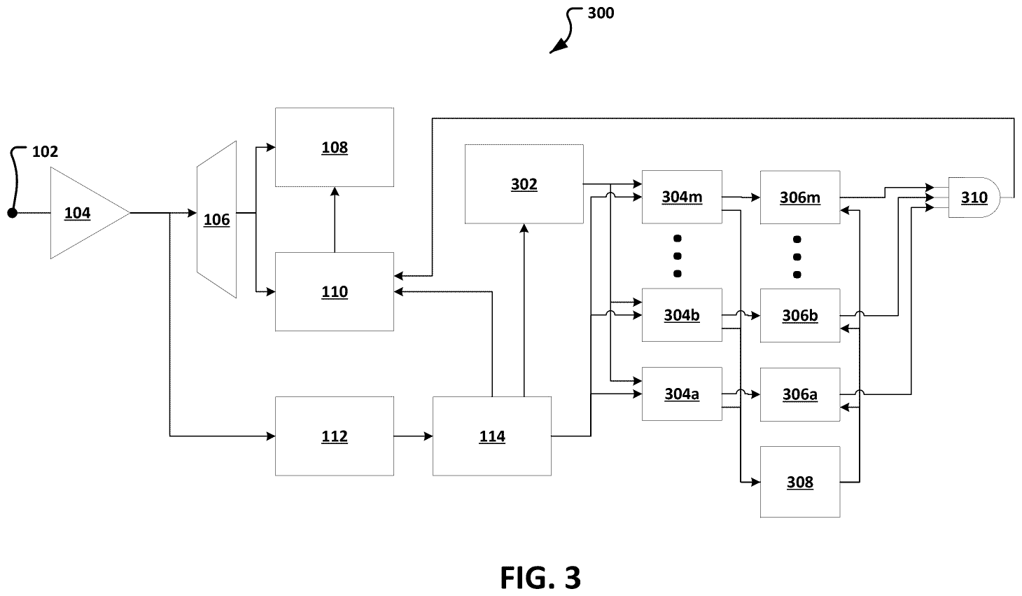

For analysis applications, ideally, the acquired waveform would have an equal number of each transition type. However, most patterns won't allow for a perfectly even distribution. A solution, according to some embodiments of this disclosure, is to have counters for each transition type that increment every time a specific transition is detected, as shown in the example of FIG. 3.

FIG. 3 is a functional block diagram of a test and measurement instrument 300 that includes counters to track the number of each detected transition type, according to some embodiments of this disclosure. As shown in FIG. 3, the test and measurement instrument 300 includes an input 102, front end circuitry which may include a preamp 104, ADC 106, acquisition memory 108, trigger circuitry 110, analog PAMn CDR 112, and Transition Detection Logic circuitry 114, which are each substantially similar to the identically numbered blocks in the test and measurement instrument 100 of FIG. 1. Additionally, the test and measurement instrument 300 also includes symbol transition count circuitry, such as a Transition Memory Controller 302, a number, m, of Transition Counters 304a, 304b, . . . , 304m, a number, m, of Count Threshold blocks 306a, 306b, . . . , 306m, a logic gate 310, and a Peak Tracker block 308.

The Transition Memory Controller 302 is coupled to the Transition Detection Logic 114. Each Transition Counter 304 is coupled to the Transition Memory Controller 302 and to the Transition Detection Logic 114. Each Transition Count 306 is coupled to one of the Transition Counters 304.

The total quantity, m, of Transition Counters 304, and Count Thresholds 306, is equal to the number of distinct symbol transitions for the PAMn signal. For example, for a PAM4 signal, there are twelve distinct symbol transitions, so m equals twelve. For a PAM8 signal, m equals fifty-six. Thus, there is a Transition Counter 304 and a Count Threshold 306 associated with each one of the respective m distinct symbol transition types. The symbol transition count circuitry is configured so that each time a particular symbol transition is detected, the associated Transition Counter's count value is incremented. The count value may then be compared to a configurable threshold value in the Count Threshold 306. The logical output of this comparison is then input to logic gate 310, which combines the outputs of all m Count Thresholds, and sends a signal to the trigger circuitry based on the combined outputs, e.g. when all of the count thresholds have been met.

The Peak Tracker 308 is coupled to each of the Transition Counters 304a, 304b, . . . , 304m, and to each of the Count Thresholds 306a, 306b, . . . , 306m. The Peak Tracker 308 is configured to track the highest count of all the possible m transitions, and can be further configured to require that all other transitions meet some percentage of the transition with the highest count. So, for example, if the 0->2 transition has been the most prevalent in the PAMn signal, having say 1000 edge occurrences, then all the other transitions need some user configurable percentage of that. According to some embodiments, the Peak Tracker 308 can automatically configure the Count Thresholds for the other transitions to a percentage of the count for the most dense transition, i.e. the peak count. The Peak Tracker 308 may be beneficial for PAMn signals in which you can't tell which transition will be the densest ahead of time.

According to some embodiments, the transition events may be stored in acquisition memory 108 adjacent to the acquired samples before or on the edge. The event would only be stored once regardless of how many samples are on the edge. It isn't that important that the event is stored with a precise sample. This is only being used to keep track of the number of each type of transition. As data is overwritten in the circular buffer acquisition memory, each transition type in the sample overwritten is decremented from the associated counter. This way the symbol transition count circuitry reflects the number of transitions in the current acquisition memory. For PAM signaling of a high order the transition data can be encoded before being stored with the acquired samples so that PAM4 doesn't require 12 bits stored in parallel with 8 or 16 bit data samples. This would consume an equivalent amount of memory bandwidth as the stored data but could be encoded to 4 bits. This would be even more important for PAM8 or PAM16.

Once there are counters that reflect the number of each type of transition, a trigger can be built on the counters. The trigger could be user configurable to have a minimum number of each transition. A user specifying a minimum of say 3000 transitions of each type would allow for statistically significant jitter calculations based on each transition type. The number of transitions necessary for the user will vary based on the standard and what they are trying to measure so would be left configurable.

Another possibility would be the user needs an approximately similar distribution of transitions. This would require tracking which of the transition types has the highest count and setting a threshold for all of the other transition types as a user configurable percentage of that count. This may be enabled by the Peak Tracker 308.

In this way, embodiments of the disclosure are able to provide the ability for a test and measurement instrument to trigger on the “density,” i.e. the prevalence of occurrences, of any particular symbol transition type, or combinations of particular symbol transition types, present in a PAMn input signal. This greatly enhances the usefulness of test and measurement instruments for analyzing and troubleshooting modern communications systems utilizing multi-level PAM standards, such as PAM4, PAM8, PAM16, etc.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

Although specific aspects of the disclosure have been illustrated and described for purposes of illustration, it will be understood that various modifications may be made without departing from the spirit and scope of the disclosure.

What is claimed is:

1. A test and measurement instrument comprising:
an input for receiving a pulse amplitude modulated n-level (PAMn) signal, wherein n is greater than or equal to three;
an analog-to-digital converter (ADC) coupled to the input to digitize the PAMn signal;
an acquisition memory coupled to the ADC and configured to store at least a portion of the digitized PAMn signal as a waveform;
trigger circuitry coupled to the ADC and to the acquisition memory, and configured to generate a trigger signal to cause the test and measurement instrument to trigger an acquisition of the waveform;
PAMn clock and data recovery (CDR) circuitry configured to decode bits from the PAMn signal; and
transition detection logic circuitry coupled to the PAMn CDR circuitry and to the trigger circuitry, and configured to detect symbol transitions based on the decoded bits, and to cause the trigger circuitry to generate the trigger signal in response to detecting a particular symbol transition.

2. The test and measurement instrument of claim 1, further comprising an amplifier coupled to the input to amplify the PAMn signal; wherein the PAMn CDR circuitry is coupled to the amplifier, and wherein the PAMn CDR circuitry comprises analog PAMn CDR circuitry structured to decode bits from the amplified PAMn signal from the amplifier.

3. The test and measurement instrument of claim 1, wherein the PAMn CDR circuitry is coupled to the ADC, and wherein the PAMn CDR circuitry comprises digital PAMn CDR circuitry structured to decode bits from the digitized PAMn signal from the ADC.

4. The test and measurement instrument of claim 3, further comprising an interpolator coupled between the ADC and the PAMn CDR circuitry.

5. The test and measurement instrument of claim 3, further comprising a continuous time linear equalizer (CTLE) coupled between the ADC and the PAMn CDR circuitry.

6. The test and measurement instrument of claim 1, wherein the PAMn CDR circuitry is implemented in an FPGA or an ASIC.

7. The test and measurement instrument of claim 1, wherein the trigger circuitry is further configured to generate trigger signals for each of m symbol transitions, wherein m equals the number of distinct symbol transitions for the PAMn signal.

8. The test and measurement instrument of claim 7, wherein the trigger circuitry is further configured to generate trigger signals for each of the m symbol transitions in a round-robin or randomized manner, so that trigger signals are generated for a substantially equal number of each of the m symbol transitions.

9. The test and measurement instrument of claim 1, further comprising symbol transition count circuitry configured to track counts of detected symbol transitions, each count associated with a respective one of m distinct symbol transitions for the PAMn signal.

10. The test and measurement instrument of claim 9, wherein the symbol transition count circuitry comprises:
a transition memory controller coupled to the transition detection logic circuitry;
m transition counters, each transition counter associated with a respective one of m distinct symbol transitions for the PAMn signal; and wherein each transition counter is coupled to the transition detection logic circuitry and to the transition memory controller;
m transition count thresholds, each coupled to a respective one of the m transition counters; and
a logic gate configured to combine the outputs of the m transition count thresholds and send a signal to the trigger circuitry based on the combined outputs.

11. The test and measurement instrument of claim 10, further comprising a peak tracker configured to determine a peak count of the counts, and to set the count thresholds as a selectable percentage of the peak count.

12. The test and measurement instrument of claim 9, wherein the symbol transition count circuitry is configured to increment a count each time the associated symbol transition is detected.

13. The test and measurement instrument of claim 9, wherein the symbol transition count circuitry is configured to decrement a count when the portion of the PAMn signal stored in the acquisition memory that contains the associated symbol transition is overwritten.

14. The test and measurement instrument of claim 9, wherein the trigger circuitry is further configured to generate a trigger signal based on a selectable combination of count values.

15. A method for operating a test and measurement instrument to trigger on symbol transitions of a pulse amplitude modulated n-level (PAMn) signal, the method comprising:
receiving a PAMn signal at an input, wherein n is greater than or equal to three;
digitizing the PAMn signal;
storing at least a portion of the digitized PAMn signal in an acquisition memory;
decoding bits of the PAMn signal, using clock and data recovery (CDR) circuitry, to determine a current symbol and a prior symbol;
detecting a symbol transition between the prior symbol and the current symbol;
configuring trigger circuitry to generate a trigger signal in response to detecting a particular symbol transition.

16. The method of claim 15, further comprising:
amplifying the PAMn signal prior to digitizing the PAMn signal; and
wherein decoding bits of the PAMn signal comprises decoding bits of the amplified PAMn signal, using analog PAMn CDR circuitry.

17. The method of claim 15, further comprising storing an indication of a detected particular symbol transition in the acquisition memory together with the digitized PAMn signal.

18. The method of claim 15, further comprising configuring the trigger circuitry to generate trigger signals for each of m symbol transitions in a round-robin or randomized manner, so that trigger signals are generated for a substantially equal number of each of the m symbol transitions, wherein m equals the number of distinct symbol transitions for the PAMn signal.

19. The method of claim 15, further comprising incrementing and decrementing count values of each of m distinct symbol transitions for the PAMn signal to reflect the quantity of each symbol transition present in the digitized PAMn signal stored in the acquisition memory.

20. The method of claim 19, further comprising:
determining a peak count value of the count values;
setting count thresholds to a selectable percentage of the peak count value; and
configuring the trigger circuitry to generate trigger signals until all of the count thresholds are met.
